(19) United States
(12) Patent Application Publication
(10) Pub. No.: US 2024/0251995 A1
(43) Pub. Date: Aug. 1, 2024

(54) SYSTEM FOR ASSISTING WITH LOADING AND UNLOADING OBJECTS

(71) Applicant: CFA Properties, Inc., Atlanta, GA (US)

(72) Inventors: Zachary Dan STEPHENS, Atlanta, GA (US); Brandon Layne WHITT, Atlanta, GA (US); Avery Alexander TURLEY, Atlanta, GA (US); Cody Jonathan ORLOVSKY, Atlanta, GA (US); Nicholas James SOAVE, Atlanta, GA (US); David William LINDBERG, Atlanta, GA (US); Chad Raymond ELLIOTT, Atlanta, GA (US); Steven Craig BAST, Atlanta, GA (US)

(21) Appl. No.: 18/416,996

(22) Filed: Jan. 19, 2024

Related U.S. Application Data
(60) Provisional application No. 63/481,959, filed on Jan. 27, 2023.

(51) Int. Cl. A47J 37/12; B66D 1/30; B66D 1/36; B66D 1/60

(52) U.S. Cl. CPC A47J 37/1271; A47J 37/1295; B66D 1/30; B66D 1/36; B66D 1/60

(57) ABSTRACT

Various devices, assemblies, components, systems, and methos are provided relating to a loading and/or unloading system. An example system may include at least one lifting portion and a movement portion. The lifting portion may be configured to move a basket in a plurality of directions to assist with loading/unloading at a plurality of stations. The movement portion may be configured to transport the lifting portion in the length direction.

### CROSS REFERENCE TO RELATED APPLICATIONS

This application claims the benefit of U.S. provisional patent application No. 63/481,959, filed Jan. 27, 2023, the disclosure of which is incorporated by reference herein in its entirety.

### BACKGROUND

The food service industry relies upon efficiently and effectively preparing food based at least in part on a made to order basis. Preparation apparatuses and devices may be used in the process to efficiently prepare orders. These preparation apparatus main goal often seek to improve the overall throughput within a kitchen environment without increasing strain on the operators. These preparation devices may operate in conjunction with other kitchen equipment (e.g., steam vent hoods, refrigerators, fryers, prep stations, loading/unloading stations, grills, warming stations, and/or the like). Applicant has identified many deficiencies and problems associated with existing methods, apparatuses, devices, and systems. Through applied effort, ingenuity, and innovation, these identified deficiencies and problems have been solved by developing solutions that are in accordance with the embodiments of the present disclosure, many examples of which are described in detail herein.

### BRIEF SUMMARY

Embodiments of the present disclosure provide methods, apparatuses, systems, computer program products and/or the like for providing assistance with loading and unloading a plurality of objects, such as food products, in a kitchen environment. In accordance with one aspect of the present disclosure, a system for providing assistance for a user with transporting one or more baskets to a plurality of stations, such as cooking stations and unloading stations.

The system may be configured to assist with movement of one or more objects in a height direction and/or in a length direction. In various embodiments, the system comprises: a lifting portion and a movement portion.

The lifting portion may be configured to assist in the moving of the one or more baskets from an upper position to and lower position. The one or more baskets may engage with one or more stations when in the extended position. The user may rotate the basket with the handle, wherein the rotation of the handle may unload the contents of the basket onto and/or in one or more stations. The lifting portion may be further configured to assist with movement in a length direction, wherein the lifting portion may move along one or more tracks of the movement portion.

### BRIEF DESCRIPTION OF THE DRAWING

The following drawings are illustrations of a particular embodiments of the present disclosure and thereof do not limit the scope or spirit of the present disclosure. The drawings are not necessarily drawn to scale, nor are they necessarily are intended for use in conjunction with the explanation in the following detailed description.

FIG. 1A illustrates a front perspective view of an example lifting portion with a basket secured to the lifting portion in accordance with various embodiments of the present disclosure;

FIG. 1B illustrates a front perspective view of an example lifting portion in accordance with various embodiments of the present disclosure;

FIG. 1C illustrates a cross-sectional view of an example connection mechanism in accordance with various embodiments of the present disclosure;

FIG. 2A illustrates a front view of an example movement portion in accordance with various embodiments of the present disclosure;

FIG. 2B illustrates a side perspective view of example rollers of a movement portion in accordance with various embodiments of the present disclosure;

FIG. 3 illustrates a side perspective view of example lifting portions on the movement portion of the system in accordance with various embodiments of the present disclosure;

FIG. 4A illustrates a front perspective view of an example lifting portion in an upper position in accordance with various embodiments of the present disclosure;

FIG. 4B illustrates a front perspective view of an example lifting portion in a lower position in accordance with various embodiments of the present disclosure;

FIG. 4C illustrates a front perspective view of an example lifting portion in a second position in the length direction in accordance with various embodiments of the present disclosure;

FIG. 4D illustrates a front perspective view of an example lifting portion in a first position in the length direction in accordance with various embodiments of the present disclosure;

FIG. 5A illustrates a front perspective view of an example windup drum in a first position in accordance with various embodiments of the present disclosure;

FIG. 5B illustrates a front perspective view of an example windup drum in a second position in accordance with various embodiments of the present disclosure; and

FIG. 6 illustrates a perspective view of an example controller in accordance with various embodiments of the present disclosure.

### DETAILED DESCRIPTION OF EXAMPLE EMBODIMENTS

Some embodiments of the present disclosure of the present invention will be described in a more detailed manner hereinafter with reference to the accompanying drawings, in which some, embodiments of the invention are shown. Reference numbers refer to elements throughout the drawings. Multiple embodiments of the current invention may be embodied in different forms and should not be limited to the embodiments set forth herein. Rather, these embodiments are provided so that this disclosure will satisfy applicable legal requirements.

As used herein, terms such as “front,” “rear,” “top,” etc. are used for explanatory purposes in the examples provided below to describe the relative positions of certain components or portions of components. As used herein, the term “or” is used in both the alternative and conjunctive sense, unless otherwise indicated. The term “along,” and similarly utilized terms, means near or on. The terms “approximately,” “generally,” and “substantially” refer to within manufacturing and/or engineering design tolerance for the corresponding materials and/or elements unless otherwise indicated. The use of such term is inclusive of and is intended to allow independent claiming of specific values listed. Thus, use of any such aforementioned terms, or similarly interchangeable terms, should not be taken to limit the spirit and scope of embodiments of the present invention. As used in the specification, the singular form of “a,” “an,” and “the” include plural references unless otherwise stated. The terms “includes” and/or “including,” when used in the specification, specify the presence of stated features, elements, and/or components, and/or groups thereof.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment. As used herein, the terms “example,” “exemplary,” and the like are used to “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component, feature, or structure “can,” “may” “could,” “should,” “would,” “preferably,” “possibly,” “typically,” “optionally,” “for example,” “often,” or “might,” or other such language, be included or have a characteristic, that component, feature, or structure is not required to be included or to have the characteristic. Such component, feature, or structure may be optionally included in some embodiments, or it may be excluded.

As described herein, the present disclosure includes one or more loading and unloading systems configured to assist with the lifting and the movement of objects along a primary track path. The depicted loading and unloading system further comprises a lifting portion and a movement portion. In some embodiments, the lifting portion may be configured to engage and/or move along with the movement portion. In some embodiments the lifting portion may comprise one or more motors, one or more actuators (e.g., rocker button, button, etc.), and/or one or more windup drums to assist in the raising or lowering of one or more baskets. In some embodiments, the movement portion may comprise at least one engagement surface and at least one track, wherein the at least one track may be configured to be secured onto the at least one engagement surface. In some embodiments, all elements of the loading and unloading system may comprise of food safe materials that can easily be cleaned and sanitized.

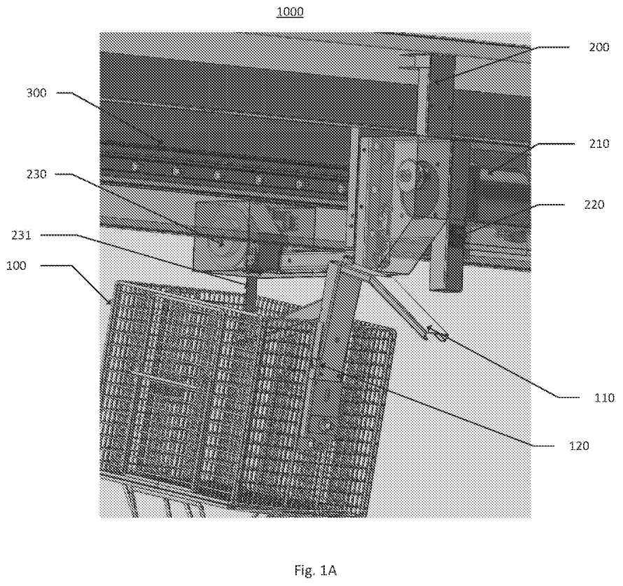

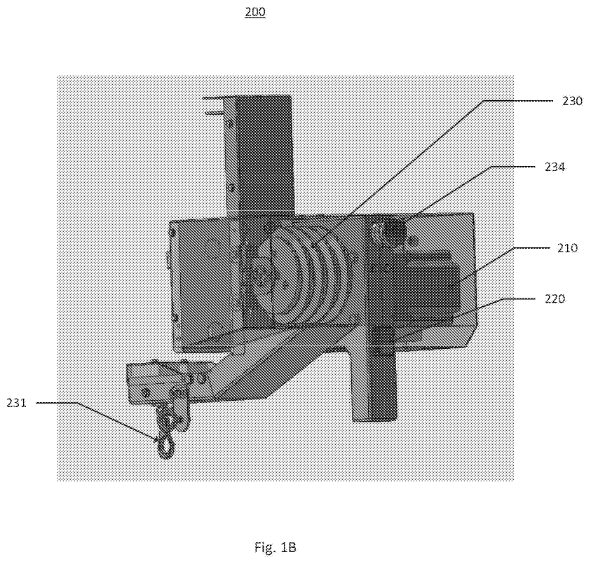

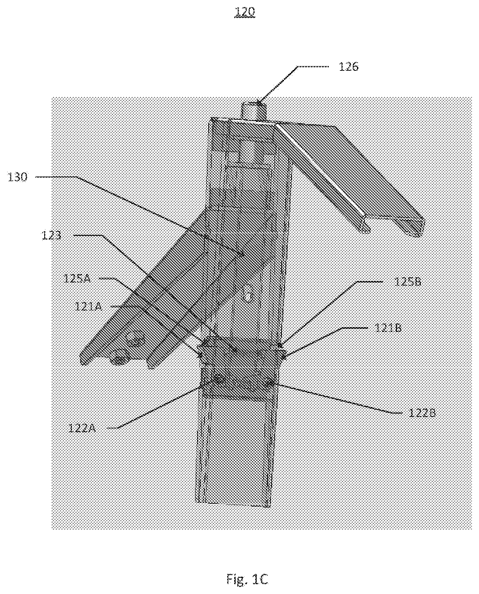

FIGS. 1A-6 depict exemplary views of example of loading and unloading systems and portions thereof in accordance with various embodiments of the present disclosure.

FIG. 1A depicts a perspective view of an example loading and unloading system 1000, which in the depicted embodiments, may include a basket 100, a lifting portion 200, and/or a movement portion 300. In various embodiments, the basket 100 may comprise a handle 110 and a connection mechanism 120. In some embodiments, the basket 100 and the handle 110 may be configured to detachably engage with each other, wherein the connection mechanism 120 may be configured to detachably secure the basket 100 to the handle 110. In various embodiments, the handle 110 may be further configured to be removable from one or more windable members 231 of the lifting portion 200. The handle 110 may be configured to be detachably connected to one or more windable members 231, such that, the handle 110 may be easily removed from the lifting portion 200 to allow for cleaning of the handle. In some embodiments, the handle 110, while detachably connected with the lifting portion 200, may be configured to be fully rotate, such that, the rotation of the handle 110 allows for the emptying of the contents of a basket 100. A user may rotate the handle 110 in clockwise and/or counterclockwise and/or forwards or backwards to empty the contents of the basket 100 at a designated location.

In various embodiments, the basket may comprise a tiered structure as described in pending U.S. Application No. 63/326,024, the contents of which are incorporated herein in their entirety. The basket may comprise a frame configured to support a top shelf and a plurality of lower shelves. The top shelf and plurality of lower shelves may be configured to be held into place by a basket frame, wherein the basket frame may comprise a first side wall and/or a second sidewall. The first sidewall and/or the second sidewall may comprise coupling slots configured to receive projecting members from each lower shelf to hold the shelf in place.

In various embodiments, the handle 110 may be configured to be detachably connected to the windable member 231 of the lifting portion 200. For example, in case of failure of the at least one motor of the lifting portion, a user may disconnect the handle from the windable member and use the handle manually (e.g., lift the handle and basket from a station). In various embodiments, the handle may be removed from the lifting portion, via detaching from the windable member, to be easily cleaned and/or sanitized. The handle may be further configured to be stored on a storage area (e.g., a hook, a shelf, a cabinet, etc.) when the handle is not in use. Further, the handle may be hung on the lifting portion when not in use by way of a hook or the like on one or both of the handle and lifting portion.

In one or more embodiments, the at least one motor of the lifting portion may comprise an encoder and may be either a DC motor or an AC motor. In various embodiments, the motor may comprise one or more limit switches and/or an absolute encoder. The absolute encoder may be configured to output and receive information regarding the speed of the motor, the outputted torque of the motor, and/or the like. In various embodiments, the one or more limit switches may be used to detect the presence and/or the absence of an object (e.g., handle, basket, etc.). The one or more limit switch may be further configured to define the travel limit of the handle and/or basket in the first direction (e.g., height direction). In various embodiments, the at least one motor may be configured to connect with and/or communicate with a PLC (e.g., programmable logic controller), wherein the PLC may determine the status of the at least one motor, the speed of the at least one motor, the torque of the motor, etc. In various embodiments, the at least one motor may comprise a plurality of different speeds, a plurality of accelerations, a plurality of upper torque limit thresholds, and/or the like. For example, in various embodiments, the at least one motor may move a handle, when not connected to a basket, in the first direction from the upper position to the lower position at a faster rate than when the handle is connected to a basket.

In various embodiments, the absolute encoder of a motor may signal and/or communicate with a PLC (e.g., programmable logic controller). The absolute encoder may output one or more signals regarding one or more rotational positions of a motor shaft. The PLC may receive the one or more signals from the absolute encoder and limit the travel of the windable member in the first direction (e.g., height direction) and/or count the number of cycles the motor completes. The PLC may be further configured to set a desired velocity and/or a desired acceleration of the motor. In some embodiments, the PLC may limit the outputted torque of the motor. In various embodiments, the motor comprises a motor shaft (not depicted), wherein a bracket (not depicted) is configured to move along the motor shaft due to the rotation. The bracket may be configured to engage with one or more mechanical limit switches in order to prevent the motor from over rotating in the upper position and/or the lower position.

In various embodiments, the at least one motor of the lifting portion may further comprise a torque limiter. The torque limiter is configured to limit the max amount of torque the motor outputs. The torque limiter can act as a safety mechanism, wherein it may be configured prevent the at least one motor from lifting one or more fryers full of oil, for example. In various embodiments, the at least motor may be configured to communicate via a plurality of communication means (e.g., wirelessly, wired, Bluetooth, IoT connectivity, etc.) with a kitchen production system of the restaurant or other connected devices in the kitchen.

With further reference to FIG. 1A, in various embodiments, the lifting portion 200 may comprise at least one motor 210, at least one actuator 220, and/or at least one windup drum 230. The motor may be in a driving engagement with the windup drum by way of a drive element (e.g., drive belt, drive chain, etc., not depicted), wherein the drive element connects to a torque output element of the motor. In some embodiments, the at least one motor 210 may be configured to assist in movement of the basket 100 from an upper position to a lower position, wherein the movement may be in a first direction. The motor may be further configured to assist in the movement of the lifting portion 200 from a first position in a second direction to a second position in a second direction. In some embodiments, the movement of the basket may be in a first direction, such that, the first direction may be in a height direction (e.g., vertically). In some embodiments, the upper position in the first direction may be a retracted position and/or the lower position in the first direction may be an at least partially extended position. In some embodiments, the movement of the lifting portion 200 may be in a second direction, such that, the second direction may be in a length direction (e.g., horizontally). In some embodiments, the first position in the second direction may be a starting position and the second position in the second direction may be an end position. In some embodiments, the user may assist with the movement the lifting portion 200 in the second direction to any one position between the starting position and the ending position.

With further reference to FIG. 1A, in various embodiments, the actuator 220 of the lifting portion 200 may be configured to activate at least one motor 210, such that, the motor may begin the movement of a handle 110 and/or a basket 100 from an upper position (e.g., a retracted position) to at least in part a lower position (e.g., an extended position) and/or vice versa. The basket 100, when fully loaded, weighs up to 26 lbs., and the total weight of the lifting portions comprising the motor, windup drum, and a fully loaded basket is greater than 40 lbs. Thus, the motor 210 applies a torque force equal to amount need to retract and/or extend a full basket The at least one actuator 220 may be a button, a rocker button, a switch, a trigger, and/or the like. In various embodiments, a user may engage with the at least one actuator 220 for a first time causing the at least one motor 210 to activate. The user may engage with the at least one actuator 220 for a second time causing the at least one motor 210 to deactivate. The activation of the at least one actuator 220 may activate the motor 210, wherein the motor 210 may be configured complete at least 100,000 cycles. In some embodiments, the at least one actuator 220 may be disposed on the handle 110. The at least one actuator 220 may be configured to be fixed to the handle, wherein the at least one actuator 220 may be dishwasher safe. In other embodiments, the at least one actuator 220 may be removable from the handle 110, wherein the removable actuator may be IP67 rated.

In various embodiments, the windup drum 230 may further comprise at least one windable member 231. The windable member 231 may comprise of a chain, a rope, a tether, a belt, a strap, and/or the like. If the windable member comprises a chain, it may be kolsterised to provide the chain with improved mechanical and/or wear properties without the reduction of corrosion resistance. The windable member 231 of the lifting portion may be configured to support up to 50 lbs. The windable member, when secured to the handle 110 assists with the movement of the handle 110 in the first direction of movement (e.g., movement in the height direction). In some embodiments, the windable member 231 secures to the handle 110, wherein the handle 110 when secured to the windable member 321 assists in the movement of the basket 100 in the first direction (e.g., height direction). The windup drum 230 is configured to unwind at least a portion of the windable member when a user engages with the actuator 220 activating the motor 210. The windup drum 230 may be configured to rotate in a first direction causing the release of at least a portion of the windable member 231. The windup drum 230 is further configured to rotate in a second direction causing the retrieval of at least a portion of the windable member 231.

With further reference to FIG. 1A, in various embodiments, the lifting portion 200 may comprise at least one additional motor (not depicted). The at least one additional motor may be used as a failsafe measure, such that, if the first motor 210 fails, the at least one additional motor may be configured to operate the same manner as the first motor. In various embodiments, the lifting portion 200 may further comprise a braking system. The braking system may be configured to prevent the basket from dropping as an unintended movement along the first direction (e.g., height direction). In some embodiments, the lifting portion 200 may comprise at least one additional windable member (not depicted) configured to engage the same handle 110 as the first windable member 231 with a centrifugal clutch. The at least one additional windable member acts as a failsafe, wherein the at least one additional windable member and centrifugal clutch can prevent the basket 100 from falling rapidly into/onto one or more stations.

FIG. 1B depicts an exemplary view of an example lifting portion and portions thereof in accordance with various embodiments of the present disclosure. In various embodiments, the lifting portion 200 may further comprise at least one emergency stop button 234. The at least one emergency stop button 234 may immediately stop the electrical current provided to the motor 210, such that, the motor 210 stops outputting a torque. The at least one emergency stop button 234 may be depressed by an operator. While in other embodiments, the operator may pull the at least one emergency stop button 234.

FIG. 1C depicts an exemplary cross-sectional view of an example connection mechanism and portions thereof in accordance with various embodiments of the present disclosure. In various embodiments, the connection mechanism 120 of a handle 110 may comprise at least two hooks actuatable 121A, 121B (collectively ‘121’), at least two pins 122A, 122B (collectively ‘122’), and/or one or more springs 123. As depicted in FIG. 1C, the connection mechanism 120 may comprise at least one detaching element 126 configured to be disposed on the top surface of the handle 110. The at least one detaching element 126 may be in the form of a lever, switch, button, and/or the like. The at least one detaching element 126 engages with one or more actuatable hook 121 via a rod 130, belt, and/or the like, wherein the rod 130 connects to the one or more actuatable hooks 121 through the column of the handle. In the depicted embodiment of FIG. 1B, the one or more actuatable hooks 121 are shown on opposite sides of the handle 110, wherein the one or more actuatable hooks 121 may be configured to be disposed within a handle column. The one or more pins 122 cooperate with the actuatable hooks to define a pivot axis for hooks in embodiments in which the hooks rotate. In some embodiments, the axes of the pins 122 may be disposed parallel to each other. In some embodiments, the pins 122 may be disposed opposite each other on a handle 110 such that, for example, a single transverse axis may intersect both pins 122 and may be perpendicular to both axes of the pins 122. In various embodiments, at least one detaching element 126 may be connected at least in part to a corresponding hook 121 and may assist in the rotation of one or more actuatable hooks, at least in part, around the corresponding pin axis. In one or more embodiments, at least partial rotation of a hook 121 may at least in part cause decoupling of a hook with a corresponding slot 125A, 125B (collectively “125”). Although FIG. 1A and FIG. 1C depict the actuatable hooks attached as part of the handle, in some embodiments, the actuatable hooks may be attached to the basket without departing from the scope of the present disclosure.

In various embodiments, the handle 110 may be coupled with the basket 100 via a user connecting the two devices together, causing the actuatable hooks to engage the slots 125 between the respective devices. In some embodiments, the handle may include the at least two hooks and the hooks may be configured to engage with corresponding slots 125 of a basket, wherein the corresponding slots may be disposed linearly opposite of each other on the basket 100. A first hook 121A may rotate in an inverse direction to a second hook 121B, such that, for example, the rotational direction for moving the first hook 121A towards the engaged position from the disengaged position is opposite the rotational direction for moving the second hook 121B towards the engaged position from the disengaged position (e.g., counterclockwise versus clockwise).

The connection mechanism may include a spring 123 which may at least in part restrict free rotation around the pin 122 in the direction of compression. With the engagement of one or more actuators, one or more hooks 121 may rotate in a corresponding direction to cause spring compression to allow for engaging and/or decoupling. In various embodiments, the user may disengage with the at least one detaching element 126 causing the at least one spring 123 to at least partially decompress and may rotate at least one actuatable hook to the original location (e.g., the engaged position, which may be the neutral position of the actuatable hooks).

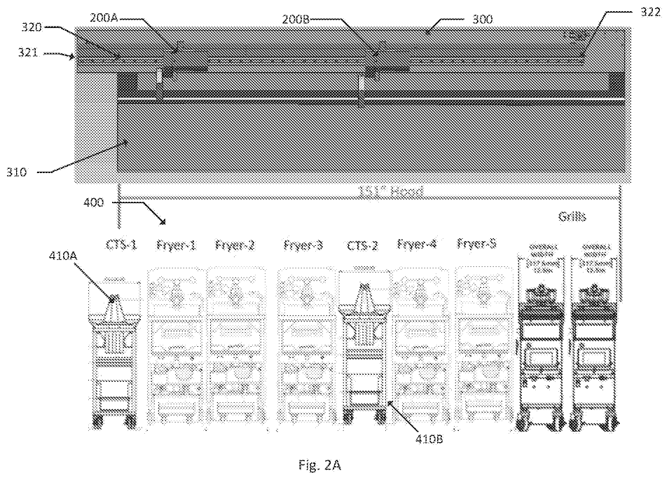

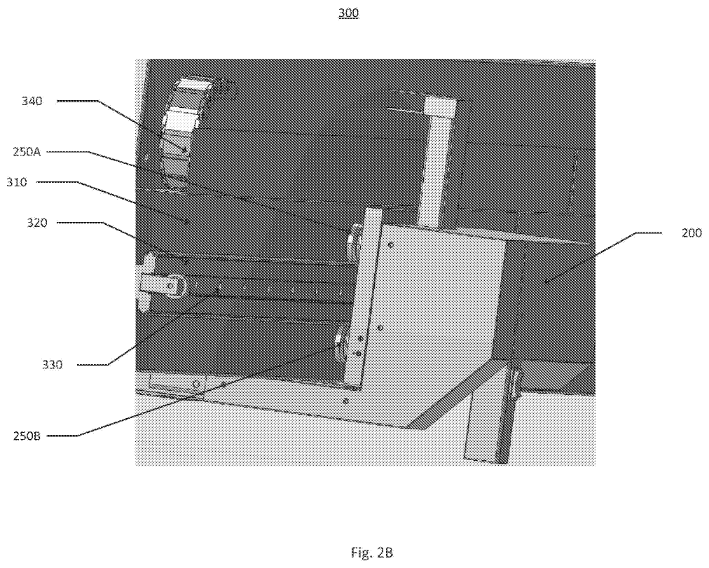

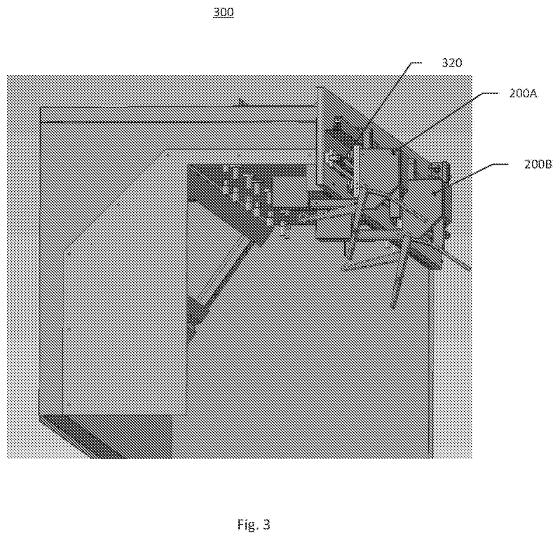

FIGS. 2A-2B and 3 depict example perspective views of an exemplary movement portion in accordance with various embodiments of the present disclosure. In various embodiments, the movement portion 300 may comprise at least one engagement surface 310 and/or at least one track 320. The at least one engagement surface 310, in some embodiments, may be a hood, a wall, etc. The at least one engagement surface 310 may be located within a kitchen environment. In various embodiments, the at least one engagement surface may be a preexisting surface located within the location the operator wants the system to be installed, such as the steam hood of an existing restaurant.

The at least one engagement surface 310 can run the length of a plurality of stations 400. The length of the movement portion 300 may depend on the number of the station 400. In the depicted embodiment, the length of the at least one engagement surface 310 is 151″. However, in other embodiments, the length of the at least one engagement surface 310 may depend on the number of stations and/or the setup of the loading/unloading environment. In various embodiments, the at least one track 320 may be configured to extend the whole length of the at least one engagement surface 310 (e.g., for example, 151″). In some embodiments, the at least one track 320 may be less than the length of the at least one engagement surface 310. In other embodiments, as depicted in FIG. 2A, the at least one track 320 may be offset from the middle, such that, the track is either right justified and/or left justified. In other embodiments, the at least one track 320 may be greater than the length of the engagement surface 310 and cantilevered beyond the engagement surface in order to engage with one or more additional stations 400 not located, at least partially, underneath the engagement surface 310.

In various embodiments, as depicted in FIG. 2A, a station 400 may be a fryer, a grill, an unloading dock, a cooler, and/or the like. In various embodiments, a loading and/or unloading station as described hereinafter may be configured to receive a basket. The loading and/or unloading station may be further configured to allow the basket to rotate allowing a to empty out the contents of the basket onto and/or into the loading and/or unloading station. The one or more stations 400 and/or one or more loading and/or unloading stations 410 may be configured to be movable via casters for each station such that the station may be moved for easier cleaning of the kitchen environment. In various embodiments, the one or more stations and/or the one or more loading and/or unloading stations may be configured to move to reorganize the layout of the kitchen environment.

Referring to FIGS. 2A-2B, the at least one track 320 may be affixed to the at least one engagement surface 310 with a plurality of fasteners 330 (e.g., depicted FIG. 2B, rivets, screws, nuts and bolts, and/or the like). The at least one track 320 defines the first position 321 (e.g., starting position) in the second direction and/or the second position 322 (e.g., end position) in the second direction. The starting position 321 may be disposed on a linearly opposite end of the at least one track 320 to the end position 322.

With further reference to FIG. 2A, in various embodiments, the at least one track 320 may be disposed vertically above one or more stations 400 such that the lifting portion 200 coupled with the basket is disposed with a height at least tall enough to clear the uppermost surface of each station. In various embodiments, the at least one track 320 may comprise of a rigid material, wherein the material may be configured to withstand the torque applied from the at least one lifting portion 200 lifting the one or more baskets from a station. The at least one track 320 may need to withstand a maximum torque of 21 lb.-ft.

With further reference to FIGS. 2A-2B and 3, the movement portion 300 may be configured to assist with the movement of at least one lifting portion 200 in the second direction (e.g., length direction). In various embodiments, as depicted in FIG. 2A, the movement portion 300 may be configured to support two or more lifting portions 200A, 200B (collectively ‘200’). The first lifting portion 200A may comprise a first set of cabling, and the second lifting portion 200B may comprise a second set of cabling. This cabling supplies power to the respective motors and is provided in extendible cable trays along either side of the engagement surface as discussed below with regards to FIG. 3. In this way, if one power supply/cabling fails, the other lifting portion will still be operable.

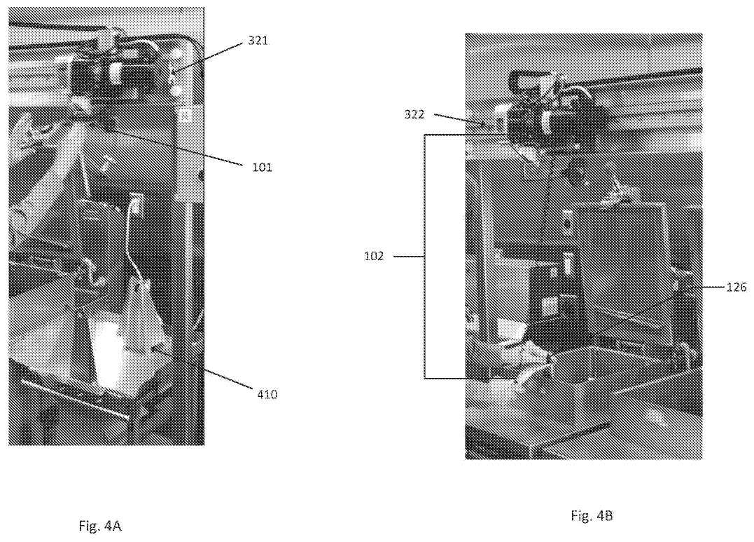

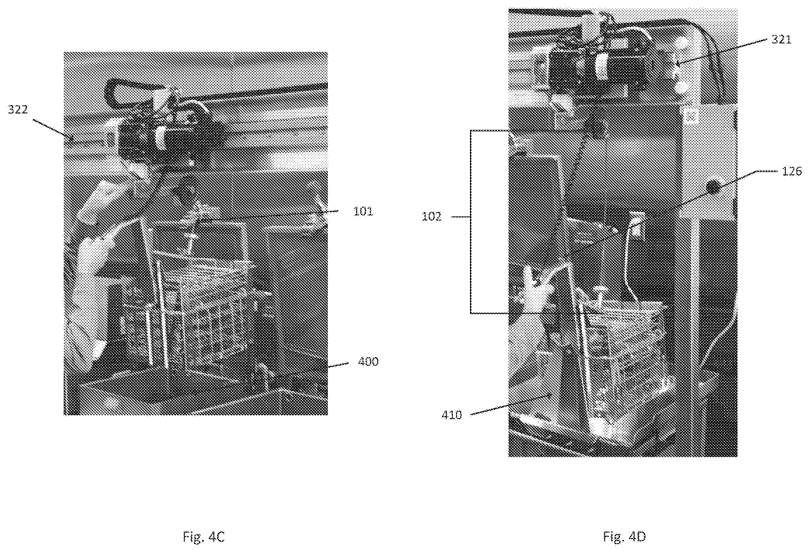

In various embodiments, a first lifting portion 200A may be disposed closer to the starting position 321 and/or a second lifting portion 200B may be disposed closer to the end position 322. The first lifting portion 200A moves in the second direction (e.g., length direction) from the starting position 321 towards the end position 322, wherein the first lifting portion 200A may engage with one or more stations 400. The first lifting portion 200A may be further configured to move a first basket 100 from the upper position (e.g., retracted position 101, depicted in FIG. 4A) in the first direction to the lower position (e.g., extended position 102, depicted in FIG. 4B) to engage with one or more stations 400. The first lifting portion 200A moves the basket 100 in the first direction, after interacting with one or more stations 400, to a first loading and/or unloading station 410A, wherein the basket may move from the upper position to the lower position 102.

In some embodiments, the second lifting portion 200B may be disposed closer towards the end position 322 than the first lifting portion 200A. The second lifting portion 200B may move a second basket 100 from the upper position (e.g., retracted position 101, depicted in FIG. 4A) in the first direction to the lower position (e.g., extended position 102, depicted in FIG. 4B) to engage with one or more stations 400. The second lifting portion 200B may be further configured to move in the second direction the basket 100, after interacting with one or more stations 400, to a second loading and/or unloading station 410B.

FIG. 2B depicts an example side view of a lifting portion engaging with a movement portion in accordance with various embodiments of the present disclosure. In various embodiments, the lifting portion 200 may further comprise at least one roller 250. The at least one roller 250 may be a wheel, a roller, and/or the like. The lifting portion may comprise two or more rollers 250A, 250B (collectively ‘250’), wherein the rollers 250 assists with the movement of the lifting portion 200 in the second direction (e.g., length direction). A first roller 250A may be disposed on a top side of the at least one track 320 and/or a second roller 250B may be disposed on a bottom side of the at least one track 320. The rollers 250 secure the lifting portion to the at least one track 320. The first roller 250A engages with a first track 320A (depicted in FIG. 4) and/or the second roller 250B engages with a second track (e.g., not depicted). In some embodiments, the lifting portion 200 may comprise at least four rollers 250. The first two rollers 250 may be disposed on the top half of the drive portion, such that, the first roller is disposed on the top left and the second roller is disposed on the top right of the lifting portion. The first and second rollers may engage with the top edge of the track 320. The third and fourth rollers may be disposed on the lower half of the lifting portion, such that, the third roller is on the bottom left and the fourth roller is on the bottom right. The third and fourth rollers may be configured to engage with the bottom edge of the track 320.

With further reference to FIG. 2B, in various embodiments, the movement portion 300 may further comprise at least one tray 340 disposed vertically above the at least one track 320. In embodiments with a plurality of tracks 320, the at least one tray is configured to be disposed vertically above the uppermost track. The at least one tray 340 is configured to house and/or store any electrical components, wires, etc. need to operate one or more lifting portions 200. In the depicted embodiments, the at least one tray 340 is configured to open, such that, the wiring can easily be accessed and/or move. The at least one tray 340 is secured to the same engagement surface 310 and in the same manner (e.g., fasteners) as the at least one track 320. The tray 340 may be equal to the length of the at least one track 320. In other embodiments, the at least on tray 340 may be greater than or less than the length of the at least one track 320.

With further reference to FIG. 3, in various embodiments, the movement portion 300 may comprise two or more tracks 320. In some embodiments, the movement portion 300 may comprise a first track 320 and/or a second track. The first track 320 may be disposed vertically above the second track (e.g., not depicted). In some embodiments, the one or more lifting portions 200A, 200B may be configured to engage with only the first track 320 In some other embodiments, the one or more lifting portions 200A, 200B may be configured to engage with on the second track. In some further embodiments, the one or more lifting portions 200A, 200B may be configured to engage with both the first track 320 and the second track.

As described herein, a lifting portion of an exemplary system may be configured such that the range of motion of a lifting portion relative to the at least one track of the system is defined by the corresponding motor coupled thereto. The user can move the lifting portion along the at least one track via pulling/pushing the lifting portion along the axis defined by the track in the second direction (e.g., length direction). For example, as illustrated in FIGS. 4A-4D, the lifting portion may be moveable through a respective second range of motion defined by the movement of the lifting portion to the at least one track 320 along a latitudinal axis defined in the second direction (e.g., length direction). For example, as illustrated by FIGS. 4A-4D, the lifting portion may be selectively configured between a starting position 321 and/or an end position 322 along the latitudinal axis defined in the second direction (e.g., length direction). For example, as illustrated in FIGS. 4A-4D, the handle may be movable through a respective first range of motion defined by the movement of the handle relative to the lifting portion along a longitudinal axis defined in the height direction. For example, as illustrated in FIGS. 4A-4D, the handle is shown as moving between an upper position (e.g., retracted position 101) and a lower position (e.g., extended position 102) along the longitudinal axis defined in the first direction (e.g., height direction).

As an illustrative example of a first step of loading and/or unloading may be depicted in FIGS. 4A-4B by the movement of the lifting portion along the latitudinal axis defined by the at least one track extended in the second direction (e.g., length direction). The first position in the second direction 321 may be configured to be dispose vertically above one or more additional stations (e.g., a grill, a fryer, etc.) As depicted in FIG. 4A, a user may push and/or pull the lifting portion along the at least one track of the movement portion to a desired location. The user may push and/or pull the lifting portion along the track, such that, the user may selectively reconfigure the lifting portion within the first position 321 (e.g., starting position) in the second direction (e.g., length direction) to the second position 322 (e.g., end position) in the second direction (e.g., length direction), wherein the lifting portion can be moved along the track from the starting position 321 (depicted in FIG. 4A) to the end position (depicted in FIG. 4B). The second position in the second direction 322 (e.g., end position, depicted in FIG. 4B) may be configured to be disposed vertically above one or more stations (e.g., a grill, a fryer, etc.). In other embodiments, the second position in the second direction 322 may be configured to be disposed vertically above one or more additional loading and/or unloading stations, wherein the one or more additional loading and/or unloading station may be disposed linearly further from the starting position.

The user may selectively stop the lifting portion at any additional point along the at least one track in between the starting position 321 and the end position 322. The one or more additional points may be configured to be one or more loading and/or unloading stations and/or one or more additional stations (e.g., a grill, a fryer, etc.). A first lifting portion may be configured to have a different starting position than one or more additional lifting portion along the same track. For example, in various embodiments, the second lifting portion starting position may be the end position of the first lifting portion.

Further, in various embodiments, a second step of loading and/or unloading may involve the lifting portion in FIG. 4A being lifted to an upper position 101 (e.g., a retracted position) in the first direction (e.g., height direction) relative to the lifting portion. After an actuator is depressed by a user activating the at least one motor of the lifting portion, the user to selectively lower the handle from the upper position in the first direction (e.g., retracted position 101) to the lower position in the first direction (e.g., extended position 102) so as to adjust the height of the handle, wherein the handle may be configured to engage a basket (depicted in FIG. 4B) and/or one or more stations (e.g., not depicted). For example, the exemplary lifting portion is shown in FIG. 4B in such an exemplary configuration, wherein the handle, upon having been moved by the activation of the motor in the first direction along the respective longitudinal axis defined in the height direction is provided in the lower position (e.g., extended position 102) relative to the lifting portion. The lower position (e.g., extended position 102) may be defined by the handle securing to the basket (depicted in FIG. 4B).

A third step of loading and/or unloading may involve the basket, securely connected with the handle via the connection mechanism, to move from the lower position 102 (e.g., extended position) to the upper position 101 (e.g., retracted position), as depicted in FIG. 4C. The user may depress the actuator of the handle a second time once the handle is securely connected with the basket in the lower position 102. The additional depression of the actuator activates the motor of the lifting portion, such that, the activation of the motor may be in the opposite rotational direction of the first depression of the actuator. The at least one motor may be configured to retract the windable member connected to that handle, wherein the retraction moves the handle and the basket, at least in part, in the first direction (e.g., height direction) towards the lifting portion. In other embodiments, the handle, secured to the basket, may be configured to move at least partially in the first direction from the lower position (e.g., extended position) to any additional position between the lower position and the upper position, wherein the additional position may depend on the length of depression of the actuator.

A fourth step of loading and/or unloading is depicted in FIGS. 4C-4D by the movement of the lifting portion with the basket along the latitudinal axis defined by the at least one track in the second direction (e.g., length direction). In various embodiments, the lifting portion may be configured, such that, the lifting portion is provided in a second position 322 (e.g., end position, depicted in FIG. 4C) in the second direction (e.g., length direction). As depicted in FIGS. 4C-4D, a user may push and/or pull the lifting portion along the at least one track of the movement portion from the second position 322 towards the first position 321. The user may move the lifting portion, with the basket secured to the handle, along the track, such that, the user may selectively control the movement of the lifting portion from the second position 322 (e.g., end position) in the length direction to the first position 321 (e.g., starting position) in the length direction. The user may selectively stop the movement the lifting portion at any one point along the at least one track. The user may move the lifting portion at least partially from the second position in the second direction 322 to one or more additional positions along the at least one track.

A fifth step of load and/or unloading may involve the basket, secured to the handle, being configured to move from the upper position 101 (e.g., retracted position) to the lower position 102 (e.g., extended position), wherein the basket may engage with a loading and/or unloading station 410, as depicted in FIG. 4D. In various embodiments, a user may rotate the handle, secured with the basket, clockwise and/or counterclockwise once the basket engages the loading and/or unloading station to empty the contents of the basket.

The user can then remove a handle from a basket once the basket engages with a loading and/or unloading station and/or once the backet has been unloaded. The user may depress the at least one detaching element 126, such that, it causes one or more actuatable hooks 121 disengage with a corresponding slot 125. The disengagement of the one or more actuatable hooks 121 may cause the basket 100 to disengage with the handle 110, wherein the basket may rest on the loading and/or unloading station 410. The user can depress the actuator 220 of the handle 110 an additional time after the disengagement of the basket with the handle. The depression of the actuator 220 of the handle 110 then activates the motor 210 of the lifting portion, such that, the motor may be configured to retract the handle 110 connected to the windable member returning the handle 110 back to the upper position.

The lifting portion and the handle may be configured to move in the first direction and the second direction simultaneously. In one or more example embodiments, the movement of the lifting portion and the handle may be configured to move in the first direction and the second direction based on, at least in part, one or more baskets ready to be loaded and/or unloaded.

The steps described above for unloading and/or unloading, may be configured to be a one-handed operation and/or a two-handed operation. For example, in various embodiments, the operation may be a one-handed operation, wherein the user controls the movement of the handle in the first direction (e.g., height direction) by depressing the one or more actuator and guiding the handle simultaneously. In a one-handed operation, the user may move the lifting portion in the second direction (e.g., length direction) by pushing and/or pulling the handle in the upper position. In various embodiments, the operation may be a two-handed operation, wherein the user engages the handle and the lifting portion simultaneously. In the two-handed operation, the user may hold the handle, connected to a basket, still while moving the lifting portion in the second direction (e.g., length direction) from a second position (e.g., end position) to a first position (e.g., starting position).

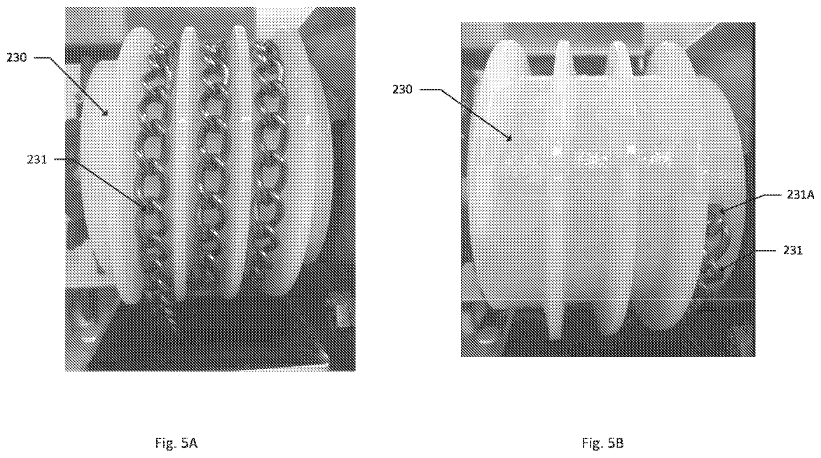

FIGS. 5A-5B illustrate an exemplary windup drum of a lifting portion in accordance with various embodiments of the present disclosure. In various embodiments, as depicted in FIG. 5A, the windup drum 230 may configure the windable member 231 to be in a fully retracted position when the lifting portion is in an upper position. The windable member 231 may be disposed fully within the windup drum 230. In various embodiments, as depicted in FIG. 5B, the windup drum 230 may unwind the windable member 231 from a fully retracted position to a fully extended position, wherein the windable member is engaged with a basket located on one or more stations. The windable member 231 may further comprise a connection point 231A, such that, the windable member 231 may be disconnected and removed from the windup drum 230. The connection point 231A allows for easy removal of a windable member 231, in a situation in which the windable member 231 has failed and/or needs to be replaced or cleaned. In various embodiments, the windup drum 230 may be configured to dispose the windable member 231 to any position between the fully retracted position (e.g., a first position) and the fully extended position (e.g., a second position).

With further reference to FIGS. 5A-5B, in various embodiments, the windable drum 230 may be a helical windup drum. The helical windup drum 230 prevents the windable member 231 from layering on top of itself during the retracting of the windable member 231. By preventing layering of the windable member, the helical windup drum 230 reduces the overall wear and noise of the windable member 231. Further, the helical windup drum 230 prevents the windable member from becoming entangled with itself during unwinding and/or winding. In some embodiments, a standard windup drum 230 may be used, wherein the diameter of the windup drum is, such that, only one layer of the windable member 231 wraps around the windup drum 230.

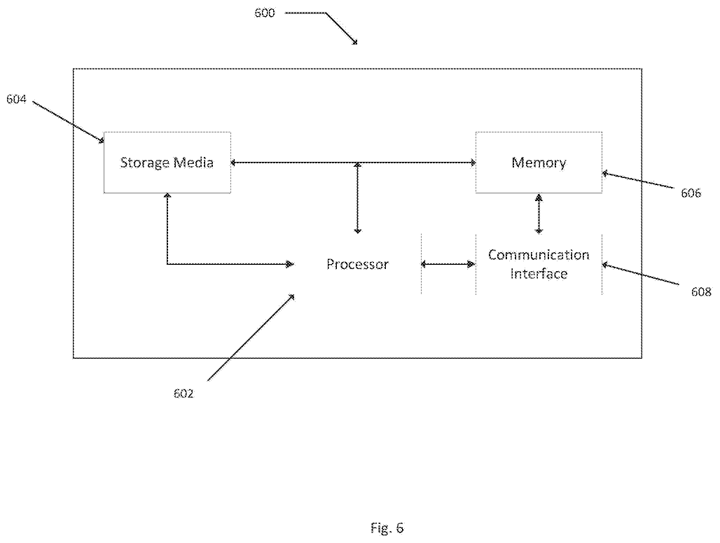

FIG. 6 is a schematic representation of example components in an example control system in accordance with various aspects of the present disclosure. As shown in FIG. 6, in one aspect, the control system 600 may be include or be in communication with one or more processing elements 602 (also referred to as processors, processing circuitry, and/or similar terms used herein interchangeably) that communicate with other elements within the control system 600 via a bus, for example, or network connection. As will be understood, the processing element 602 may be embodied in a number of different ways. The control system 600 may further include or be in communication with memory 606 (also referred to as volatile storage, memory element, memory circuitry and/or similar terms used herein interchangeably).

The control system 600 may further include or be in communication with non-volatile media. The controller 600 may be configured to store data on one or more storage media 604, wherein the data may comprise information regarding: number of uses of the lifting portion, how often the lifting portion is used, time stamps of when the lifting portion is used, the location of the lifting portion, any fault and/or failures of the lifting portion, and/or the like. The controller may be further configured to store data regarding the counting of the number of cycles completed, such that, the controller may prevent operation once a predefined number of cycles has been reached until a component has been replaced. For example, the controller may prevent operation and/or present an alarm once the motor has hit 140,000 cycles to service the windable member. After the windable member had been serviced, the controller may reset the count.

According to some aspects, the control system 600 may be a computer product including at least one non-transitory computer-readable storage medium 604 having computer-readable program code portions stored therein. The computer-readable program code portion may include an executable portion. The executable portion may be configured to assist in prevent the at least one motor from applied too much torque when raising a basket. The executable portion may further be configured to ensure that the failsafe equipment of the at least one additional cable and/or the at least one additional motor in the event of a power loss.

Many modifications and other embodiments of the present disclosure set forth herein will come to mind to one skilled in the art to which this disclosure pertains having the benefit of the teachings presented in the foregoing description and the associated drawings. Therefore, it is to be understood that the present disclosure is not to be limited to specific embodiments disclosed and that modifications and other embodiments are intended to be included within the scope of the description. Moreover, although the foregoing description and the associated drawings describe example embodiments in the context of certain example combination of elements and/or functions, it should be appreciated, in light of the present disclosure, that different combinations of elements and/or functions than those explicitly described above are also contemplated as can be set forth in some of the description. Although specific terms are employed herein, they are used in a generic and descriptive sense only and not for purpose of limitation.

1. An apparatus for assisting in lifting and lowering fryer baskets in a kitchen of a restaurant, the apparatus comprising:
at least one track mounted above one or more stations and defining a length;
at least one lifting portion mounted to the track for horizontal movement along at least a portion of the length of the track, wherein the lifting portion comprises;
at least one motor;
at least one windup drum connected to the motor and configured to rotate therewith;
at least one windable member secured to the windup drum and configured to be wound and unwound therefrom;
at least one handle secured to the windable member and configured to be lifted to a retracted position and lowered to an extended position as the windable member is wound and unwound therefrom, wherein the handle is configured to be connected to a fryer basket; and
at least one actuator operably connected to the motor, wherein the actuator is configured to actuate the motor to rotate the windup drum, wind the windable member onto the windup drum, and lift the handle and fryer basket.

2. An apparatus for assisting in lifting and lowering fryer baskets according to claim 1, further comprising a connection mechanism for detachably securing the handle to a basket.

3. An apparatus for assisting in lifting and lowering fryer baskets according to claim 2, wherein the connection mechanism further comprises one or more actuable hooks for detachably securing the handle to a basket.

4. An apparatus for assisting in lifting and lowering fryer baskets according to claim 3, wherein the connection mechanism further comprises at least one detaching element for engaging the actuable hooks to detach the handle from a basket.

5. An apparatus for assisting in lifting and lowering fryer baskets according to claim 4, wherein the detaching element comprises a button on a top surface of the handle.

6. An apparatus for assisting in lifting and lowering fryer baskets according to claim 3, wherein the connection mechanism comprises at least one spring that presses the one or more hooks into an engaged position.

7. An apparatus for assisting in lifting and lowering fryer baskets according to claim 1, further comprising at least two lifting portions each being mounted to the track for horizontal movement.

8. An apparatus for assisting in lifting and lowering fryer baskets according to claim 1, further comprising one or more rollers for assisting in movement of the lifting portion along the track.

9. An apparatus for assisting in lifting and lowering fryer baskets according to claim 1, wherein the track is affixed to a steam hood of a restaurant.

10. An apparatus for assisting in lifting and lowering fryer baskets according to claim 1, wherein the windable member comprises a chain.

11. An apparatus for assisting in lifting and lowering fryer baskets according to claim 10 wherein the windup drum comprises a helical track for receiving the chain as the chain is wound onto the windup drum.

12. An apparatus for assisting in lifting and lowering fryer baskets according to claim 1, wherein the windable member comprises a belt.

13. An apparatus for assisting in lifting and lowering fryer baskets according to claim 1, further comprising a controller.

14. A method for moving fryer baskets, the method comprising:
moving a lifting portion horizontally along a track mounted above one or more stations to a position above a fryer station having a fryer basket with fried food therein;
engaging an actuator to rotate a motor operably connected to a windup drum to lower a handle connected to the windup drum by a windable member;
connecting the handle to the fryer basket;
engaging the actuator to rotate the motor and the windup drum to wind up the windable member and lift the handle and the fryer basket connected thereto;
moving the lifting portion horizontally along the track to a position above an unloading station; and
rotating the basket to empty the fried food from the basket into the unloading station.

15. A method for moving fryer baskets according to claim 14, further comprising moving the lifting portion horizontally along the track, after rotating the basket to empty the fried food into the unloading station, to a position above a loading station and loading the basket with unfried food.

16. A method for moving fryer baskets according to claim 15, further comprising moving the lifting portion horizontally along the track, after loading the basket, to a position above a fryer station.

17. A method for moving fryer baskets according to claim 16, further comprising engaging the actuator to rotate the motor and windup drum to unwind the windable member and lower the fryer basket into the fryer.

18. A method for moving fryer baskets according to claim 14, further comprising removing the handle from the windable member for cleaning.
